(19) United States
(12) Patent Application Publication
(10) Pub. No.: US 2022/0122113 A1
(43) Pub. Date: Apr. 21, 2022

(54) PROVIDING OFFERS

(71) Applicant: Harmony International DMCC, Dubai (AE)

(72) Inventors: Parag Rameshchandra Gathani, Dubai (AE); Deep Nalin Vyas, Dubai (AE)

(21) Appl. No.: 17/505,968

(22) Filed: Oct. 20, 2021

Related U.S. Application Data
(60) Provisional application No. 63/094,693, filed on Oct. 21, 2020.

(51) Int. Cl. G06Q 30/02

(52) U.S. Cl. CPC G06Q 30/0224; G06Q 30/0204; G06Q 30/0236

(57) ABSTRACT

Disclosed is a system for providing an offer to a user. In an example, the system obtains a plurality of offers being provided by a corresponding offer provider. The system segments the plurality of offers based on a set of pre-defined categories, wherein the set of pre-defined categories are defined based on offer provider, offer attributes relating to offer, product offerings, and service offerings to which the offer relates to. On receiving user information relating to a user, determine target category for the user from the set of pre-defined categories based on the received user information, wherein the user information indicates at least one user selected offer provider, and a selected category. Based on the determination, the system may transmit the offer from the target category.

### CROSS-REFERENCE TO RELATED APPLICATIONS

This application claims priority to and the benefit of U.S. Patent Application No. 63/094,693, filed Oct. 21, 2020, and titled “Providing Offers Data”. The foregoing application is incorporated herein by reference in its entirety.

### BACKGROUND

Offers pertaining to goods or services may be provided to prospective customers as a part of sales promotions. Such offers may be provided by, for example, manufacturers, retailers, merchants, vendors, outlets, financial institutions (such as a bank, credit card service providers, and the like), loyalty clubs, membership clubs, and so forth. An offer may enable a customer to avail an allowance or a concession, such as a financial discount, an additional value-added service, or other benefits, while purchasing a product or while availing a service. To such an end, the customer may redeem the offer by using a unique identifier associated with the offer, wherein the unique identifier may be a coupon code, a promocode, a barcode, a computer-readable image, and the like.

### BRIEF DESCRIPTION OF THE DRAWINGS

The following detailed description references the drawings, wherein:

FIG. 1 illustrates a system for automated offer delivery an aggregating system for providing an offer to a user, as per an example;

FIG. 2 illustrates an example environment where a system is being implemented, as per an example;

FIG. 3 illustrates a user interface provided by a system, as per an example;

FIG. 4A-4C illustrates a user interface provided on a user device, as per another example

FIG. 5 illustrates a method for providing an offer to a user, as per an example;

FIG. 6 illustrates method for receiving information from an offer provider, as per example; and

FIG. 7 illustrates a computing environment implementing a non-transitory computer readable medium for automated offer delivery to a user, as per an example.

Throughout the drawings, identical reference numbers designate similar, but not necessarily identical, elements. The figures are not necessarily to scale, and the size of some parts may be exaggerated to more clearly illustrate the implementation shown. Moreover, the drawings provide implementations and/or examples consistent with the description, however, the description is not limited to implementations provided in the drawings.

### DETAILED DESCRIPTION

An offer may be proffered by an offer provider for enabling sale of a product or a service under special conditions, such as discounted price, added service, added product, and the like. A user may be affiliated to the offer provider, who may then share the offers with such affiliated users. A user may redeem an offer to accrue savings on spending. A user may redeem an offer, for example, using a unique identifier associated with the offer, by performing transaction using a financial card providing the offer, and so forth. To such an end, the unique identifier may be, for example, a coupon code, a promocode, a barcode, a computer-readable image, and the like.

Typically, an offer provider may provide a number of offers, wherein such offers have corresponding offer attributes such as conditions, terms, validity, and so forth. Examples of the offer providers include, but are not limited to, retailers, merchants, vendors, outlets, restaurants, manufacturers, financial institutions, corporates, hospitality service providers, e-commerce websites, loyalty clubs, membership clubs, multinational brands, and so forth. These offers may then be provided to the user who are affiliated to the corresponding offer provider or to users who may have subscribed to receiving such offers. In such cases, not all offers are provided. Such offers are provided typically based on categories or types of offers which may have been predefined or elected by the user, or based on their affiliations or memberships with the offer providers.

Conventionally, information pertaining to offers are disorganized. Moreover, a user may be affiliated with multiple offer providers, each of whom may be providing large number of offers spread across different categories, and provided at different platforms. To access plurality of offers, the user may have to scour multiple sources, such as websites, emails, social media platforms, messages, and so forth, to locate the relevant and accurate offers for use. Furthermore, the status of these offers is also static. For example, a user may revisit email communication about an offer at a later date only to find that the offer is no longer valid and has expired. Owing to dispersed and complex nature of information relating to offers, the user may not be able to discover a relevant offer based on a present requirement thereof. In an example, the user may fail to fully comprehend a value of different offers thereby failing to identify a most relevant offer that would give the best value in terms of savings. In certain cases, some of the previously identified offers that the user may wish to redeem for an ongoing transaction may not be redeemable, i.e., may have expired. As a result, the user may fail to redeem any offer while performing a transaction. Typically, searching through such multiple sources may be time-consuming and may potentially lead to user frustration. Keeping a track of such offers is not possible.

In certain cases, a third-party platform may provide a list of offers that may be relevant to the user. However, such platform may require the user to provide personal information associated with the user. In an example, the platform may request information such as, mobile number, e-mail address, credit card number, debit card number, membership number, employee id, and so forth, from the user in order to provide offers relevant to the user. The information requested from the user may be imbibed with personal and critical data and may have security risks associated thereto. To such an end, the user may not feel comfortable in providing the personal information thereby missing out on offers that the user is entitled to and this may further affect purchasing pattern of the user.

Furthermore, a third-party platform may capture information pertaining to offers from public domain, for example, by crawling a plurality of platforms associated with a plurality of offer providers. However, the information pertaining to offers available in the public domain is highly inaccurate owing to lack of authentication of such information. In certain cases, some offers identified by the third-party platform may be invalid, expired, or fraudulent. In such cases, use of such offers by the user may have security threats associated therewith and may cause bouncing of transaction, thereby hampering experience of the user. In addition, the third-party platform may make available an offer's information to the user after an elapsed time. Such non-timely delivery of the offer's information to the user may render the offer's information futile, specifically, in cases where the offer is time-sensitive. Such challenges dilute the utility of such offers, deny multitude of benefits to the users, and also negate the effectivity of such business promotion measures implemented by different goods and services providers.

Approaches for providing an offer to a user, are described. It may be noted that the term ‘offer’ as used herein broadly encompasses any kind of allowance or concession on a product or a service that may be redeemed by the user. The offer may include, but is not limited to, cash discount, cash back, percentage discount, shipping discount, value added offer, member-exclusive reward, product bundling discount, subscription offer, loyalty reward, deal, influencer's offer, referral offer, feedback offer, offline offer, online offer, and coupon-based discounts. The offer may be provided by an offer provider.

A system for automated offer delivery may be implemented through executable instructions. An offer may be provided by a corresponding offer provider, wherein an offer may have associated offer attributes. Examples of the user device include, but are not limited to, personal computer, laptop, portable computing device (such as tablet, smartphone, notebook computer), and personal digital assistant (PDA).

In operation, the system may communicate with a plurality of offer providers to obtain a plurality of offers. For example, the system may communicate with an offer provider via an application programming interface (API) obtain a plurality of offers. Examples of the offer provider may include, but are not limited to, an entity selling a product or the service (such as, a brand, a seller, a vendor, a merchant, an outlet, and the like) and/or a third-party entity such as an e-commerce website, a hospitality management institution, an aggregating platform, a financial institution, a corporate, a membership or loyalty club, and the like.

The system may then segment the plurality of offer based on a set of pre-defined categories. The set of pre-defined categories are defined based on offer provider, offer attributes relating to offer, product offerings, and service offerings to which the offer relates to. To such an end, each of the plurality of offer may relate to one or more of the set of pre-defined categories. In an example, the pre-defined categories may be based on a sector of industry of the product offerings and service offerings, a geolocation of service, a time period of validity, and an offer provider.

Continuing further, the system may receive user information relating to a user. For example, the user may provide the user information to raise a request for offers from the system. The user information may indicate user preference relating to offer provider of offer, i.e., at least one user selected offer provider, a selected category, and location of the user. The user information may also include, for example, email address of the user, name of the user, contact number of the user, and membership details that the user is affiliated to.

Based on the received user information, the system may determine target category for the user from the set of pre-defined categories. Based on the user information, the user may prefer or may be eligible for certain offers belonging to certain pre-defined categories. Such pre-defined categories, that may include offers in which the user may be interested and/or offers for which the user may be eligible, may be determined as the target category for the user. The target category may include one or more pre-defined categories from the set of pre-defined categories. Moreover, the target category may have associated offers, i.e., offers belonging to the determined target category.

Once the relevant offer is determined, such offer may be provided to the user. For example, the offer may be provided to the user as a notification, a pop-up message, an SMS, an email, a pop-up notification, and the like.

The system as described in the present application acquires offer directly from a corresponding offer provider or through reliable network, thereby ensuring authenticity of the offer and security of a user. Further, the system may validate the stored plurality of offer periodically to ensure that an offer provided to a user is active and up to date. In this manner, the system ensures substantially reduced bounce rate of an offer provided to the user, thus enhancing shopping experience of the user. The system does not request for any critical data from the user thereby ensuring security of the user. Due to segmentation of the plurality of offer, prompt determination and retrieval of an offer relevant to the user may be performed. The system also enables an offer provider to provide time-sensitive offer, wherein such time-sensitive offer may be delivered to the user in real-time. Thus, reduced latency of the time-sensitive offers ensures that the user makes informed decisions while purchasing a product or a service.

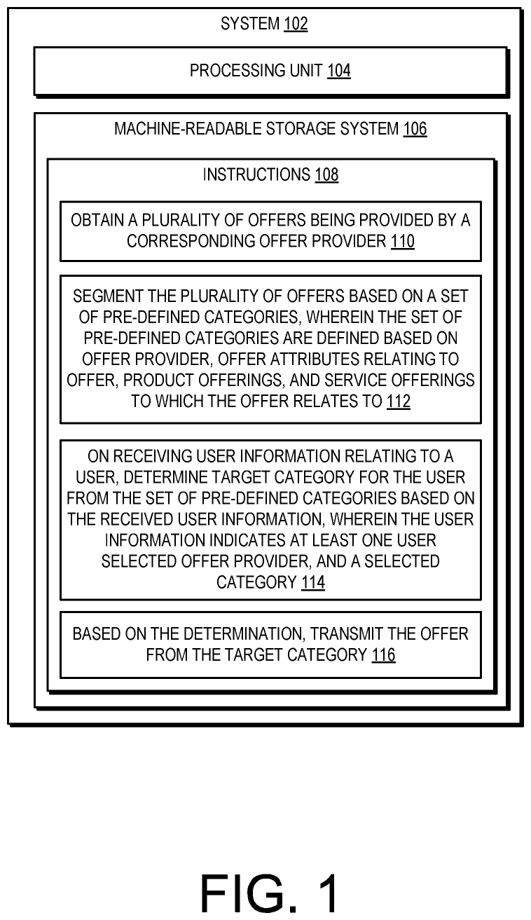

FIG. 1 illustrates an example system 102 for automated offer delivery, according to an example of the present subject matter. The system 102 may be any processor enabled device which performs certain specific functions. The system 102 may be further in communication with a computing device (not shown in FIG. 1) associated with an offer provider and a user device (not shown in FIG. 1) associated with a user. An example of the system 102 includes, but is not limited to, a remote server. The system 102 may be either a standalone device or in communication with other systems (not shown in FIG. 1) over a communication network. The present approaches may also be implemented in other types of the system 102 without deviating from the scope of the present subject matter.

The system 102 includes a processor 104, and a machine-readable storage medium 106 which is coupled to, and accessible by, the processor 104. The system 102 may be a computing system, such as a storage array, server, desktop computer, a laptop computer, a smartphone, a distributed computing system, or the like. Although not depicted, the system 102 may include other components, such as interfaces to communicate over a network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM, or non-volatile memory such as EPROM, flash memory, and the like. The instructions 108 may be executed to determine occurrence of an anomaly in the target computing device, based on the analysis of the current operating parameters of the target computing device.

In an example, the processor 104 may fetch and execute instructions 108. For example, as a result of the execution of instructions 110, the system 102 may obtain a plurality of offers being provided by a corresponding offer provider. An offer may be provided as a sales promotion or for a user's membership or affiliation to certain services. The offer may relate to a product or a service that may be consumed by a user, after paying a relating amount, i.e., the purchase price. In an example, the plurality of offers may be obtained from different offer providers, via corresponding offer provider server.

The plurality of offers may be segmented based on a set of pre-defined categories, as a result of the execution of instructions 112. The set of pre-defined categories may be defined based on offer provider, offer attributes relating to offer, product offerings, and service offerings to which the offer relates to. In an example, an offer may be segmented into one or more categories from the set of pre-defined categories. For example, the pre-defined categories may be based on a sector of industry of the product offerings and service offerings, a geolocation of service, a time period of validity, and an offer provider.

In an example, such sector may include, but are not limited to, healthcare, food, tourism, beauty and grooming, clothing and apparel, electronics and appliances, grocery, web service, furniture, sports, educational, mobile services, and so forth. The geolocation may indicate, for example, a location, such as a store, an outlet, a region, a state, and the like, where an offer is valid. It may be noted that such a sector of industry relating to the product offerings and service offerings of an offer, a geolocation of an offer, a time period of validity of an offer, and an offer provider may be determined based on offer attributes of the offer.

With the plurality of offers being segmented, the system 102 may be ready to serve a request from a user. Subsequently, instructions 114, when executed by the system 102 may cause the system 102 to receive user information relating to a user. The user information may indicate at least one user selected offer provider, and a selected category. In an example, the user information may also include a user location. Based on the user information, the system 102 may determine target category for the user from the set of pre-defined categories based on the received user information. In particular, the target category may include one or more pre-defined categories that may be relevant to the user, i.e., offers associated with such target category may be relevant for the user. For example, the target category for the user may be determined based on the selected category and/or user preferences, such as the user selected offer provider. In certain cases, the target category for the user may be determined based on other user preferences, such as the user location, user activity, and so forth.

Once determined, the system 102, may transmit the offer from the target category, as a result of execution of instructions 116. In particular, after determining the target category for the user, the system 102 may retrieve offers segmented with the target category. As may be understood, such offers from the target category may be relevant to the user.

In an example, the system 102 may authenticate validity of the retrieved offer belonging to the target category. In this regard, the system 102 may determine if the offer is active or valid, based on offer attributes indicating term of validity of the offer. For example, the system 102 may also assess offer attributed based on certain parameters to determine if the offer is fake or spam. such parameters may include, for example, source of the offer, web links associated with the offer, a feedback pertaining to an offer, and missing information or offer attributes relating to the offer. Once validated, the system 102 transmit validated offer from the target category to the user.

The above described techniques implemented as a result of the execution of the instructions 108 may be performed by different programmable entities. Such programmable entities may be implemented through computing systems, which may be implemented either on a stand-alone computing device, or multiple computing devices. These and other examples are further described with respect to other figures.

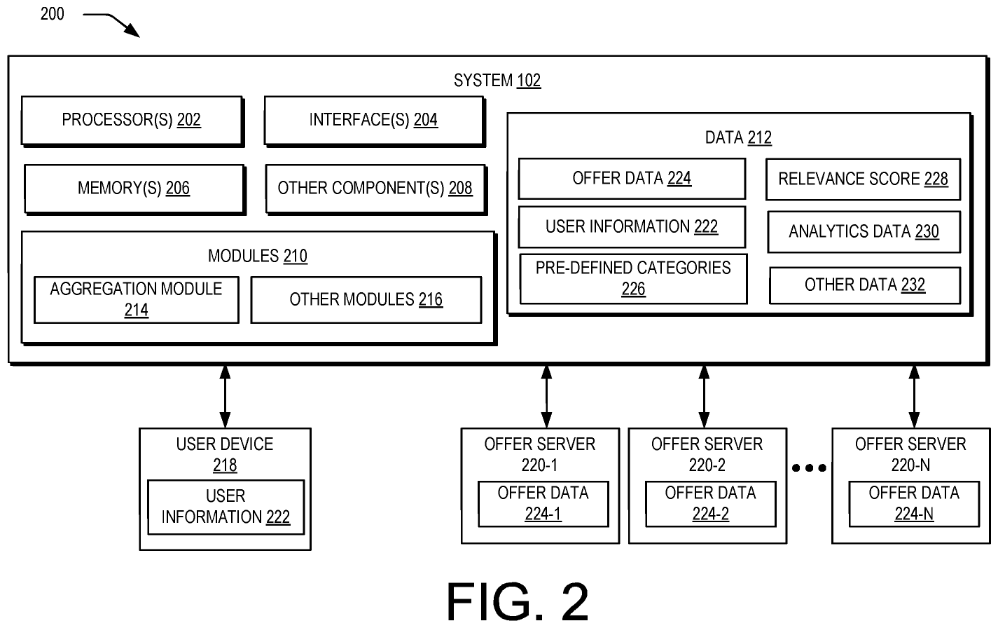

FIG. 2 illustrates an example environment 200 where the system 102 is being implemented, as per an example of the present subject matter. The system 102 includes processor(s) 202, interface(s) 204, memory(s) 206, and other components 208. The system 102 also includes module(s) 210 and data 212. The processor(s) 202 may be implemented as a combination of hardware and programming, for example, programmable instructions to implement a variety of functionalities of the module(s) 210. In examples described herein, such combinations of hardware and programming may be implemented in several different ways. For example, the programming for the processor(s) 202 may be executable instructions. Such instructions may be stored on a non-transitory machine-readable storage medium which may be coupled either directly with the system 102 or indirectly (for example, through networked means). In an example, the processor(s) 202 may include a processing resource, for example, either a single processor or a combination of multiple processors, to execute such instructions. In the present examples, the non-transitory machine-readable storage medium may store instructions that, when executed by the processor(s) 202, implement the module(s) 210.

The interface(s) 204 may include a variety of software and hardware interfaces that allow the system 102 to interact with other devices, such as the computing device of the provider and the user device, in addition to other devices such as network entities, web servers, and external repositories, and peripheral devices such as input/output (I/O) devices (not shown in FIG. 1 for sake of brevity). The memory(s) 206 may include any computer-readable medium known in the art including, for example, volatile memory, such as Static Random-Access Memory (SRAM) and Dynamic Random-Access Memory (DRAM), and/or non-volatile memory, such as Read-Only Memory (ROM), Erasable Programmable ROMs (EPROMs), flash memories, hard disks, optical disks, and magnetic tapes.

The module(s) 210 may be implemented as a combination of hardware and programming (for example, programmable instructions) to implement a variety of functionalities of the module(s) 210. In examples described herein, such combinations of hardware and programming may be implemented in several different ways. For example, the programming for the module(s) 210 may be executable instructions. Such instructions in turn may be stored on a non-transitory machine-readable storage medium which may be coupled either directly with the system 102 or indirectly (for example, through networked means). In an example, the module(s) 210 may include a processing resource (for example, either a single processor or a combination of multiple processors), to execute such instructions. In the present examples, the processor-readable storage medium may store instructions that, when executed by the processing resource, implement module(s) 210. In other examples, module(s) 210 may be implemented as electronic circuitry.

The module(s) 210 include an aggregation module 214, and other module(s) 216. The aggregation module 214 may be implemented as software products recorded on machine-readable non-transient data storage media. The aggregation module 214 may be executed upon computing hardware devices, such as a remote server, a plurality of user devices, a plurality of computing devices, and so forth. Examples of a manner in which the system 102 or the aggregation module 214 may be implemented includes, but is not limited to, a website, a web-plugin, a web application, and android application, an iOS application, or a combination thereof. The other module(s) 216 may further implement functionalities that supplement applications or functions performed by the system 102 or any of the module(s) 210.

Moreover, the system 102 may be in communication, through a network, with a user device 218 and a plurality of offer servers, depicted as offer servers 220-1, 220-2, . . . , 220-N. The network may be a private network or a public network and may be implemented as a wired network, a wireless network, or a combination of a wired and wireless network. The network may also include a collection of individual networks, interconnected with each other and functioning as a single large network, such as the Internet. Examples of such individual networks may include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The user device 218 may relate to a user of the system 102. The user may use the user device 218 to raise a request for offers with the system 102. Examples of the user device include, but are not limited to, personal computer, laptop, portable computing device (such as tablet, smartphone, notebook computer), and personal digital assistant (PDA). In an example, the user may raise the request for offers by providing user information 222 to the system. For example, the user information 222 may include information, such as name, user location, at least one user selected offer provider, and a selected category.

Continuing further, the plurality of offer servers 220-1, 220-2, . . . , 220-N (collectively referred to as offer servers 220) may provide functionality to offer providers' computing device. For example, an offer provider may access the associated offer server, say 220-1, via a computing device. The offer provider may provide or upload offer data 224-1 relating to an offer on the offer server. Further, the system 102 may interface with the offer server 220-1 to obtain the offer data 224-1, via an application programming interface (API). In this manner, the system 102 may obtain plurality of offer data 224-1, 224-2, . . . , 224-N from the offer servers 220.

Although the present example describes an offer being obtained from an offer server of an offer provider. However, such retrieval of offer data should not be considered as a limitation. In certain cases, an offer provider may register with the system 102 to create an offer provider profile. In particular, the offer provider may provide offer provider parameter information to the system 102. For example, the offer provider parameter information may include, but are not limited to, name, contact details, at least one location associated with offer provider, an industry of service, administrator details relating to the offer provider, a sales verification number relating to the offer provider, and transactional information.

Further, the offer provider may provide offer data relating to an offer proffered by the offer provider, to the system 102. Based on the offer provider parameter information and offer data provided by the offer provider, an offer provider profile may be created for the offer provider. For example, the system 102 may update the offer provider profile based on activity of the offer provider on the offer provider profile.

Using the offer provider profile, the offer provider may directly upload offer data onto the system 102. In this regard, the system 102 may also provide a selection of a plurality of templates to the offer provider, via the offer provider profile. The plurality of templates may have, for example design themes, text boxes, selection of media, media box, selection of drop-down menu, touch and/or press buttons, toggle buttons, and the like, to enable the offer provider to create an offer data. For example, the system 102 may provide editing tools, writing tools, formatting tools, uploading tools, and so forth for creation of an offer. Based on the plurality of templates, the offer provider may create an offer data for an offer. Such offer created by an offer provider may be uploaded and made available for use or consumption in real-time.

Returning to the present example, the data 212 includes data that is either stored or generated as a result of functionalities implemented by the module(s) 210 or the system 102. It may be further noted that information stored and available in the data 212 may be utilized by the module(s) 210 for providing an offer to the user. The data 212 may include offer data 224, user information 222, and pre-defined categories 226. The data 212 further includes relevance score 228, analytics data 230 and other data 232. The offer data 224 may relate to an offer and may have corresponding offer attributes and other parameters based on which it may be ascertained if the offer is relevant to the user. The system 102 may further include instructions for providing offer to the user, based on the user information 2222, offer data 224 and offer attributes relating to the offers. The offer attributes and other parameters relating to offers may include data or values of different attributes pertaining to the plurality of offers. The offer attributes and other parameters may be derived by processing the offer data 224.

In operation, the system 102 may obtain offer data, say offer data 224-1, relating to an offer being provider by an offer provider, via corresponding offer server 220-1. In this regard, the aggregation module 214 may interface with the offer server 220-1 associated with the offer provider, wherein the offer provider may upload the offer data 224-1 on the offer server 220-1. In an example, the aggregation module 214 defines an API in real-time, based on properties of the offer server 220-1 associated with the offer provider to acquire the offer data 224-1. For example, the properties of the offer server 220-1 may include, but is not limited to, format of data on the offer server 220-1, policies of the offer server 220-1, language of the offer server 220-1, and so forth. Moreover, example of information included in the offer data 224-1 include, but are not limited to, offer content, bank type, card type, provider information, validity, terms and conditions, and category of offer (for example, healthy, lifestyle, food, clothing, and so forth).

To this end, an offer may include, but is not limited to, cash discount, percentage discount, shipping discount, value added offer, member-exclusive reward, product bundling discount, subscription offer, loyalty reward, deal, influencer's offer, referral offer, feedback offer, offline offer, online offer, and coupon-based discounts. The offer may be provided by an entity selling the product or the service (such as, a seller, a vendor, a merchant, an outlet, and the like) and/or a third-party entity such as an e-commerce website, a financial institution, a corporate, a loyalty club, and the like. For example, the offer provider may be a financial institution that issues service cards to the user and provides offers on certain products and/or services based on type of affiliation, i.e. type of card, of the user to the financial institution.

After acquiring, the aggregation module 214 processes the offer data 224-1 in order to segment the offer data 224-1 based on the predefined categories 226. For example, the predefined categories 226 for segmenting the offer data 224-1 may include, but is not limited to, location, validity, card type, issuer of card, platform of card, offer type, offer provider, and so forth.

In an example, the aggregation module 214 may then normalize the received offer data 224-1, 224-2, . . . , 224-N. For example, the aggregation module 214 may normalize the offer data 224-1, 224-2, . . . , 224-N based on a set of indexes so as to improve offer data integrity. For example, the offer data 224-1, 224-2, . . . , 224-N may be enriched by obtaining certain offer provider parameter information and/or information relating to indexes from other sources, such as the Internet. Further, the offer data 224-1, 224-2, . . . , 224-N is then stored within a memory associated with the system 102 as offer data 224. In an example, on determining that the offer data 224-1 has incomplete or missing information, the aggregation module 214 may interface with the offer server 220-1 to acquire the missing information. If the missing information is not available on the offer server 220-1, the aggregation module 214 may raise a request with the offer provider for supply of the missing information. For example, the request for the missing information may be raised via an automated e-mail to the offer provider or an entity associated with the offer provider, such as a marketing team, a business team, a customer care team, and so forth. Moreover, the offer data 224-1 having missing information may be flagged within the offer data 224 to ensure that such offer is not provided to the user or is provided to the user with a warning message.

Further, the aggregation module 214 may receive user information 222 from the user, via the user device 218. In an example, the aggregation module 214 may receive access request from the user device 218. On receiving the request, the aggregation module 214 enables the user to provide user information. The system may store such user information as user information 222. For example, the user information 222 may include, but are not limited to, a type of card associated with the user (such as, debit card, credit card, loyalty card, and the like), a platform of the card (such as VISA, Mastercard, RuPay card, and the like), an issuer of the card (such as, a bank name, a loyalty club name, a membership, a subscription, and the like), a format of the card, location of the user, at least one user selected offer provider, and a selected category of offer. It is to be noted that the aggregation module 214 does not request for any personal information of the user, such as card number, personal identifier, membership number, and so forth. It may also be noted that by way of the user information 222, the user may define a present requirement of the user based on which an offer is desired. For example, the user may define the present requirement based on, a card issuer type, a card type, a provider, an outlet, a geolocation, and the like.

On receiving the user information 222 from the user device 218, the aggregation module 214 determines target category for the user from the pre-defined categories 226. In an example, the user information 222 may include at least one selected offer provider and a selected category. In such a case, the target category may correspond to the selected category and the at least one user selected offer provider.

In certain cases, the aggregation module 214 may process the user information 222 to determine the analytics data 230. In an example, the aggregation module 214 may obtain user transaction history relating to the user. As may be understood, the user transaction history may indicate offer providers associated with user transactions performed by the user. Further, the aggregation module 214 may determine a segmentation corresponding to the offer providers, based on the pre-defined categories 226. Such segmentation of offer provider may indicate purchase or transaction trend of the user in terms of offer provider and/or industry of product/service. Subsequently, the aggregation module 214 may derive the analytics data 230 for the user. Based on the segmentation of the offer providers associated with the user transaction history, the analytics data 230, and the user information 222, the user may be segmented into some of the pre-defined categories 226. For example, the user may be segmented into the predefined categories 226 based on, for example, demographic group, user's budget, user's requirement, attitude and trend of the user, user preferred offer provider, and so forth. Based on the segmentation of the user, target category for the user may be determined. The target category may include the category within which the user may have been segmented based on user activity and user preferences.

In an example, the user may create a user profile by registering with the aggregation module 214. In such a case, the aggregation module 214 may trigger a user profile creation module (not shown in FIG. 2) of the system 102 to aggregate user information 222 including, for example, e-mail address, username, mobile number, location, preferences, identifier of the user device, card type, bank name, loyalty name, selected category, at least one user selected offer provider, or a combination thereof, and store the user profile within a memory associated with the system. The user profile creation module may associate the user information 222 with an identifier of the user in order to create the user profile. For example, the user profile creation module may further operate to acquire information such as, interactions of user with the user device 218, searches performed on the user device 218, websites crawled on the user deice 218, identifier of the user device 218, behavior of the user 218, and so forth. For example, such information may be acquired from the user device 218 if privacy settings of the user device 218 and/or the user allows accessibility to such information. In one example, the user profile creation module may store all the user information 222 of the user with the corresponding identifier as a user profile in a memory associated with the system 102. The user profile created by the user profile creation module may be utilized by the aggregation module 214 in order to keep the user continually updated with new and/or relevant offer. Moreover, the aggregation module 214 may dynamically update the user profile based on activity of the user on the user profile.

Once the target category for the user is determined, offer from the target category may be provided to the user. In an example, the aggregation module 214 may authenticate validity of the offers from the target category. Thereafter, the aggregation module 214 retrieves the validated offer and provides it to the user, via the user device 218. For example, the aggregation module 214 may provide the offer on the user device 218, via a push notification, a message, an app notification, an e-mail, and the like.

In an example, the aggregation module 214 may determine a plurality of offers that may be relevant to the user. In this regard, the aggregation module 214 may determine a relevance score for each of the offers from the target category to be provided to the user. For example, the relevance score for an offer may be determined based on corresponding offer provider parameter information, validity, the user information and an amount of saving. In an example, relevance of the offer for the user may be determined by matching the user information with the offer provider parameter information and offer attributes of the offer. An offer having high relevance to the user, high reliability, and high benefit may be allocated a high relevance score. The relevance score for the offers from the target category may be stored as relevance score 228. Thereafter, the aggregation module 214 may arrange the offers from the target category in a list, based on the corresponding relevance score. The list may have the offer having highest relevance score at the top. The aggregation module 214 may then transmit the list of the offers from the target category to the user.

The aggregation module 214 may, automatically or on user's command, sort the offers from the target category based on, for example, location, distance, provider, extent of saving, and so forth. Further, such offer relevant to the user may be provided on a user dashboard executing on the user device 218, wherein the user dashboard may be rendered on the user device 218 in response to the user profile.

In an example, the aggregation module 214 may receive user location relating to the user. For example, the user location may indicate a current geolocation of the user. Such user location may be provided as user information 222. The user location has an associated local geofence. As may be noted, the local geofence may form a virtual perimeter around the real geolocation of the user. Based on the local geofence and determined offers from the target category, offer that may be valid within the local geofence of the user may be determined. Subsequently, such offer may be assigned a higher relevance score before transmitting the list of offers. In an example, a new offer belonging to target category may be provided to the user in real-time, i.e., when the user enters the geofence or when the new offer is uploaded or obtained. In this manner, the user may be provided with relevant offer associated with location near the user's current or predicted location. Therefore, the offers that may be time-sensitive and time-specific may be reliably provided to target user. As such, the offer may be provided to users that are commonly located in an area of the offer provider offering the offer, at specific time of day during which the offer is most relevant or valid.

The aggregation module 214 may enable the user to set a reminder pertaining to an offer. For example, the user may have identified an offer to be relevant but may not have used the offer at the time. Subsequently, if the user may wish to user the offer at a later time, the user may send a reminder setting request relating to the offer. On receiving the reminder setting request from the user device 218, the aggregation module 214 may retrieve offer provider parameter information relating to offer provider of the offer. The offer provider parameter information may include an offer provider location. i.e., a geolocation or a website where the offer may be applied. The aggregation module 214 may then track geolocation of the user device 218 or user activity on the user device 218 to determine if the user location or user activity may correspond to utilization of the offer. In an example, on determining a geolocation of the user to match with the offer provider geolocation, the aggregation module 214 may transmit a reminder relating to the offer to the user. In another example, on determining the user to access the website on which the offer may be availed, the aggregation module 214 may transmit the reminder relating to the offer to the user.

In one example, the aggregation module 214 may be tracking the geolocation of the user device 218. When geolocation of the user may change to a new location, the aggregation module 214 may determine at least one offer provider within a local geofence of the new location. The aggregation module 214 may determine the at least one offer provider based on the user information 222 and the target category for the user and offer provider parameter information relating to plurality of offer providers. Further, the aggregation module 214 may send a trigger to the determined at least one offer provider. Such trigger indicates a user profile relating to the user. Based on the trigger, an offer provider within the local geofence of the new location may provide a first offer. The aggregation module 214 may receive such first offer and transmit the first offer to the user. For example, such first offer may not be accessible publicly.

In order to provide relevant offer, the aggregation module 214 may obtain user activity data relating to the user. In an example, user activity data indicates an ongoing session corresponding to a transaction. The ongoing session may relate to purchase of a product or a service by the user, say on the user device 218. Based on the user activity data and the user information 222, the aggregation module 214 may determine an offer for the user, wherein such offer may be valid for the ongoing session. The aggregation module 214 may then cause to apply the determined offer to the ongoing session. In this manner, even if the user forgets to retrieve or apply an offer, the user's savings are not affected.

For example, the aggregation module 214 may determine an amount of benefit associated with each of the offers from the target category. In this regard, the aggregation module 214 may calculate an amount of savings by applying each of the offers from the target category on an ongoing session. Based on the determination, a selected offer providing highest amount of benefit may be indicated to the user. In an example, the selected offer may be indicated in bold, or using a different color, font, and the like.

The aggregation module 214 may enable the user to provide a feedback of the offer provided to the user. In one example, the aggregation module 214 enables the user to provide the feedback, for example, once the user has redeemed or utilized a provided offer. Further, such feedback may be provided by way of a rating, a text review, a picture review, and so forth. In certain cases, the user may report an offer provided thereto owing to invalidity of the offer. In such cases, the aggregation module 214 may take down the reported offer and/or communicate with a provider of the offer to resolve the reported offer. In an example, the analytics data 230 corresponding to the user may be updated, based on the feedback provided by the user.

It may be noted that the system 102 or the aggregation module 214 may be communicatively connected to a plurality of user devices associated with a plurality of users. Such user may raise request for offers using the associated user device. Furthermore, the aggregation module 214 may circulate an offer among a set of users from the plurality of users of the system 102 in real-time, i.e., instantaneous to an upload time of the offer. It may be noted that the offer may be provided to the set of users owing to relevancy of the offer for the set of users based on, for example, target category, location, card type, financial institution, and so forth. In one example, the aggregation module 214 may interact with an offer provider of the real-time offer data to communicate that the user has been served with the offer data.

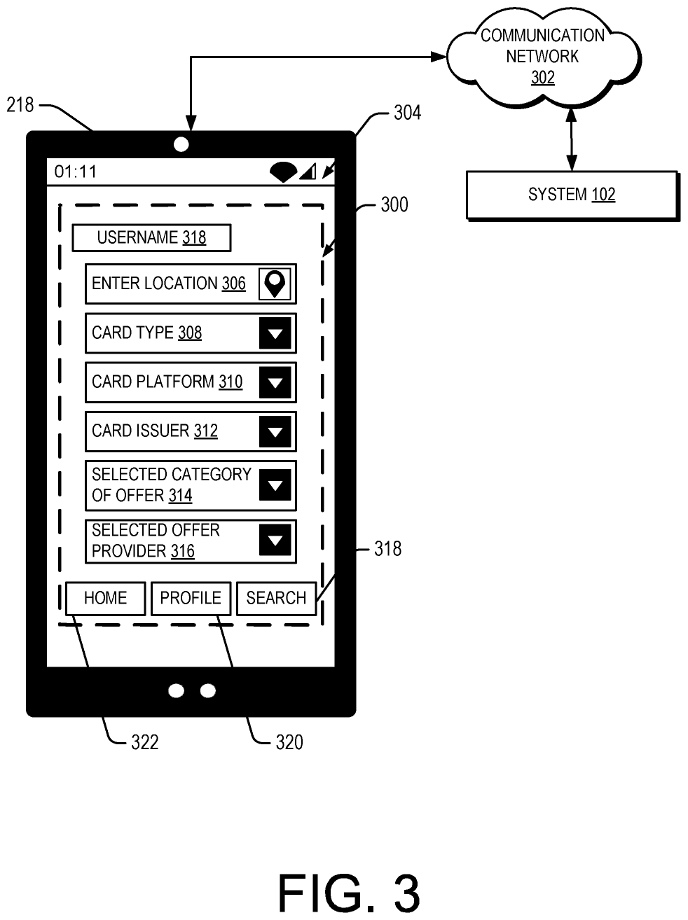

FIG. 3 illustrates a user interface 300 provided by a system 102, as per an example. In response to interaction of a user with the system 102, the system 102 may render the user interface 300 on a display device 304 of a user device 218. The user interface 300 may enable the user to provide user information (such as the user information 222) and search for offer. For example, the user information 222 may be stored in a memory associated with the system 102.

In an example, a request from the user may be raised when the user opens a website or logs-in on a website associated with the system 102. Thereafter, an aggregation module, such as the aggregation module 214 may render the user interface 300 on user device 218. Such user interface 300 may enable the user to provide the user information 222 via text boxes, selection of images, selection of drop-down menu, touch and/or press buttons, toggle buttons, and so forth. Based on the user information 222, a user profile corresponding to the user may be created. In an example, the user interface may be customized based to the user information 222 or the user profile. By providing the user information 222, the user may raise a request for receiving offer relating to current requirement or preference of the user. In an example, the user may generally browse through plurality of offers relevant to the user.

While interacting with the user interface 300, the user may perform a variety of functions and operations associated with the system 102, such as launch interface(s) of the user interface 300, raise a request for offers, provide user information 222, provide a selected offer provider, provide a selected category, select an offer, and so forth. The user may provide the user information 222 including, for example, a location of the user at 306 (such as by inputting the location or identifying the location using a Global Positioning System (GPS) of the user device 218), a preferred type of card associated with the user at 308 (such as, debit card, credit card, loyalty card, and the like), a preferred platform of the card at 310 (such as VISA, Mastercard, RuPay card, and the like), a preferred issuer of the card at 312 (such as, a bank name, a loyalty club name, a membership, a subscription, and the like), a selected category of offer at 314 (such as, food, lifestyle, clothing, pharmacy, and the like), and a selected offer provider at 316 (such as, a brand, an outlet, an e-commerce, and the like). Further, the user may have a unique identifier, such as a username 318 associated thereto It may be noted that abovementioned user information 222 may be provided using dropdown menu, text box, toggle buttons, push button, touch button, or any other type of input field. Moreover, examples of such user information 222 provided using the user interface 300 is only illustrative and should not be construed as limiting in any way.

In this regard, the user may tap or click on the search button 318 to raise the request for offers with the system 102. The user information 222 provided by the user, via the input fields 306, 308, 310, 312, 314 and 316 may be communicated to the system 102 using a communication network 302, such as a Wide Area Network, Internet, and the like. The system 102 or an aggregation module 214 of the system 102 may process the user information 222 including the location 306, card type 308, card platform 310, card issuer 312, selected category of offer 314, and selected offer provider 316. Based on the user information 222, the aggregation module 214 may determine target category for the user. Subsequently, the aggregation module 214 may determine offer relevant to the user. The offer is then displayed on the display device 304 of the user device 218, wherein the user may select an offer data to redeem it. The user may also, via the user interface 300 on the user device 218, save an offer, set reminder pertaining to an offer, provide feedback corresponding to it, share the offer, and so forth.

It may be understood that the user interface 300 also enables the user to manage the user information 222, such as by changing and/or adding user information. The user interface 300 described in the present example is only illustrative and should not be construed as limiting in any way. In other implementations of the present subject matter, the user interface 300 may include other input fields, media, and so forth.

For example, the user interface 300 may display, on the user device 218, at least one card of the user, at least one financial institution used by the user, at least one loyalty membership associated with the user, at least one preference or interest of the user, and so forth. In an example, user interface 300 displaying such user information relating to the user may be accessed by the user by tapping or clicking on the profile button 320. Further, the user may access homepage of website associated with the system 102 using the home button 322.

In an example, the aggregation module 214 may perform validation of the stored offer data 224 in a periodic manner to ensure reliability of the offer data 224. In one example, the aggregation module 214 may validate the offer data 224 to remove any expired, invalid or fraudulent offer. In one example, an offer provider may upload a time-sensitive offer using the aggregation module 214. Such time-sensitive offer data may have limited duration of validity, for example, 1 hour, 6 hours, 1 day, and the like. Further, such time-sensitive offer data may be provided to a user in real-time.

Once the user receive offer from target category, the user may redeem, save or forward any of the offer. To consume or redeem an offer, the user may send a request for consumption to the system 102. In this regard, the aggregation module 214 may receive the request of consumption relating to the offer from the user. In an example, the aggregation module 214 may reveal a unique identifier pertaining to the offer, wherein using the unique identifier pertaining to the offer the user may avail the offer. Moreover, the aggregation module 214 may provide a set of instructions, such as steps, to avail the offer. In an example, the user may have to purchase the offer from the aggregation module 214. In such a case, the request of consumption may include transaction data relating to the user, wherein based on the transaction data the user may initiate a purchase session. In this manner, the aggregating module 214 may provide a payment gateway for purchase of the offer. Once the transaction is successfully completed, the aggregation module 214 may provide a unique identifier pertaining to the offer to enable the user to redeem the offer.

To share an offer, the user may send a sharing request relating to an offer. In this regard, the aggregation module 214 may receive the sharing request relating to the offer. Such sharing request may indicate a second user profile associated with a second user. In an example, the second user profile may be a user profile on the system 102, or may be a user profile on other platforms, such as social media platform, email service platform, message service platform, and the like. Based on the second user profile, the aggregation module 214 may transmit the offer to the second user.

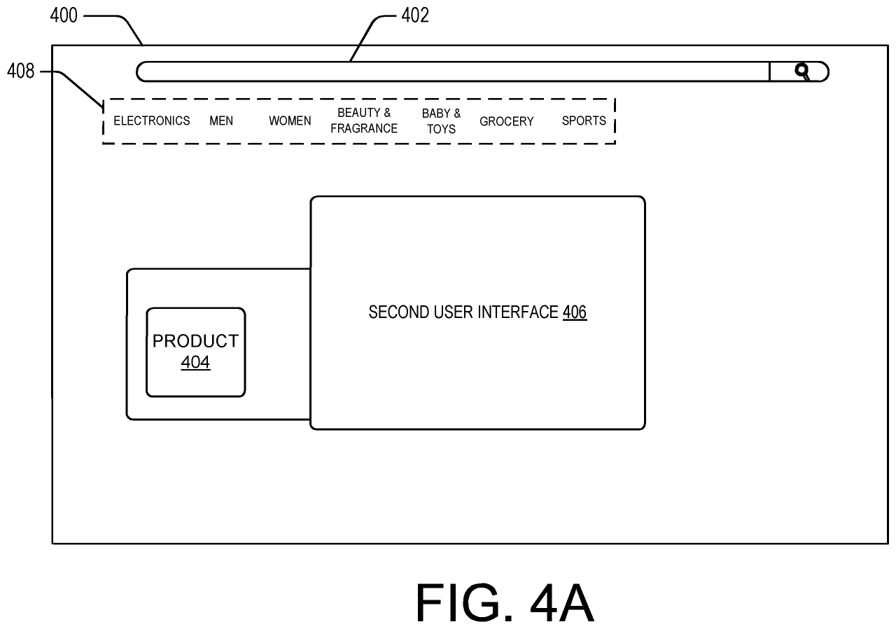

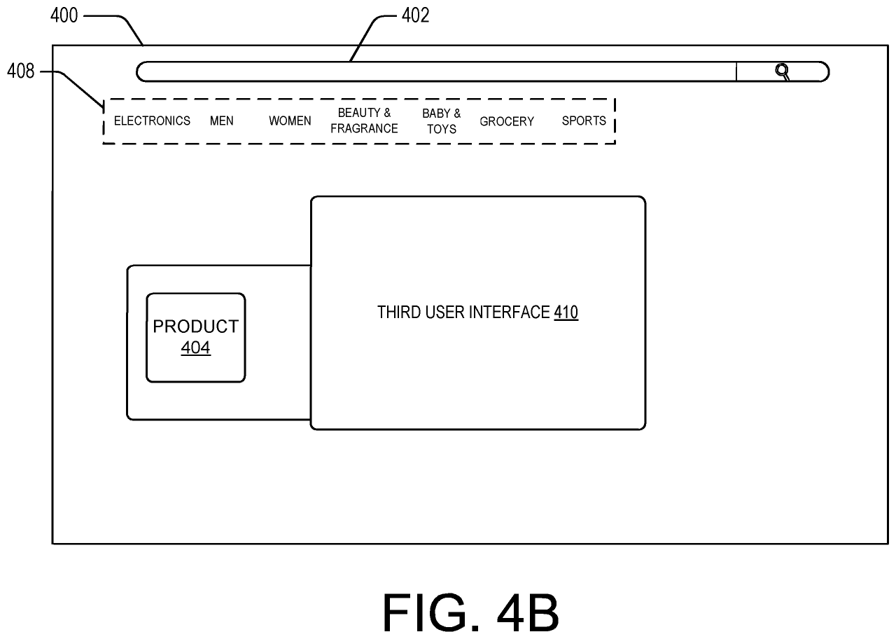

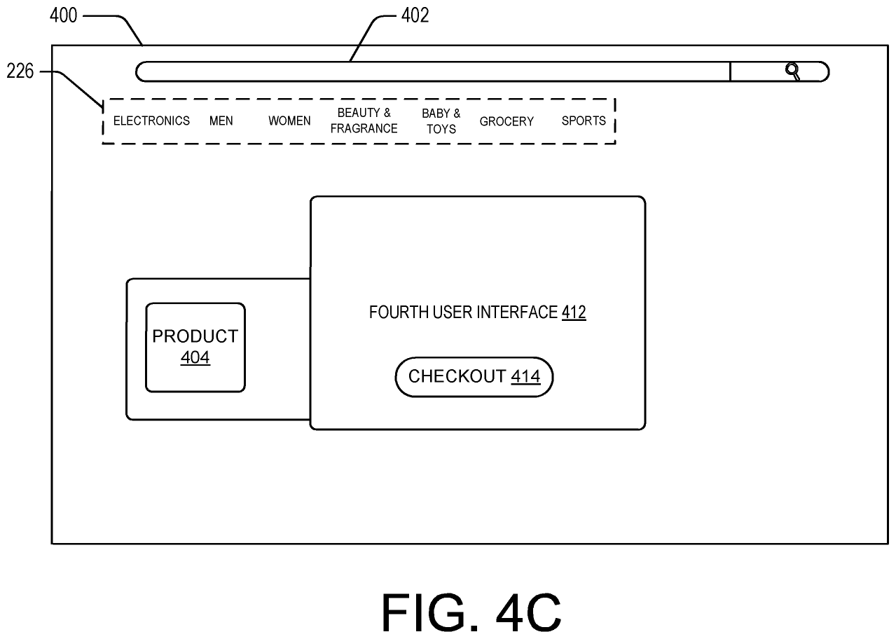

FIGS. 4A-4C illustrates a user interface 400 provided on the user device 218, as per an example. In particular, the user interface 400 is provided to the user during an ongoing session. The ongoing session as used herein may refer to an interaction of the user via the user device 218 with a seller of a product or service. For example, the seller may be an e-commerce website, a brand website, a financial service provider's website, and so forth. In an example, the ongoing session may correspond to adding of a product to a cart on an e-commerce website. In this regard, the user may access the cart to perform a transaction for purchasing a product 402. In addition, the user interface 400 may have a search bar 404 to enable the user to search for products on the e-commerce website

Pursuant to present example, the system 102 may provide a browser extension on the user interface 400. In this regard, the user may register with the system 102 and may install the browser extension on the user device 218 onto a web browser associated with the user device 218. The browser extension relating to the system 102 may be represented as, for example, a logo, an icon, a text, and a graphical representation, on the user interface 400. For example, the browser extension may run, based on user information 222 provided by the user and/or user activity, such as the ongoing session.

Referring to FIG. 4A, the browser extension may provide a second user interface 406, wherein the second user interface 406 may be provided as an overlay onto the user interface 400. In particular, the second user interface 406 may be provided by the system 102 when the system 102 is assessing the user information 222 and/or user activity. In particular, the system 102 may determine target category for the user from a set of pre-defined categories 408 based on the received user information 222 and the user activity, such as, the ongoing session, user activity history, and so forth. In this regard, the second user interface 406 may indicate that the system 102 is determining or finding offers for the user. For example, the system 102 may provide the second user interface 406 on determining that a cart on the e-commerce website is being accessed by the user. Such determination may be made based on, for example, display of “checkout” or “proceed to pay” tab on the user interface 400.

Referring to FIG. 4B, the browser extension may provide a third user interface 410 on the user interface 400. In particular, the third user interface 410 may be provided by the system 102 when the system 102 determines offers from the target category for the user. For example, such offers may be pertinent to the ongoing session associated with the product 402. In an example, the third user interface 410 may provide a number of offers that may be pertinent to the ongoing session and may further be clicked on by the user. In an example, when tapped or clicked, such third user interface 406 may expand to provide a list of offers. In this regard, the user may select an offer to apply one of the list of offers to perform a transaction relating to the product. In an example, the system 102 may cause to apply a selected offer from the determined offers on the ongoing session, wherein such selected offer may provide highest saving on the purchase of the product in the cart. For example, the system 102 may determine the selected offer by applying each of the list of offers to determine the highest amount of saving from the selected offer. In an example, the browser extension may also provide comparative overview of savings that may be availed corresponding to different offers. Based on determining which offer is likely to yield the maximum savings. In another example, one of more offers may be selected and may be applied to select items shortlisted by the user for purchase. In this manner, offers with prospects of providing maximum savings may be applied for selected items thereby providing better flexibility for users to avail offers in one go.

Referring to FIG. 4C, the browser extension may provide a fourth user interface 412 on the user interface 400. In particular, the fourth user interface 412 may be provided by the system 102 when the system 102 or the user applies a selected offer from the offers provided to the user. In an example, the system 102 or the user may apply the selected offer to initiate a transaction for purchase of the product 402. For example, the user may then click the checkout tab 414 to continue with the transaction.

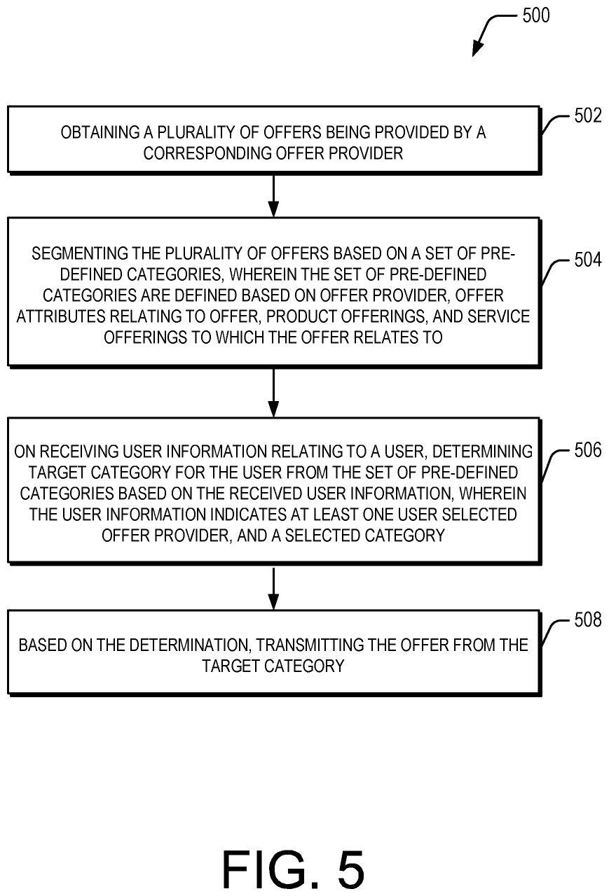

FIG. 5 illustrates a method 500 for providing an offer to a user, as per an example. Although the method 500 may be implemented for providing the offer by a variety of systems, for the ease of explanation, the present description of the example method 400 is provided in reference to the above-described system 102. The order in which the method 500 is described is not intended to be construed as a limitation, and any number of the described method blocks may be combined in any order to implement the method 500, or an alternative method.

It may be understood that blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 5, at block 502, plurality of offers are obtained. Each of the plurality of offers is provided by a corresponding offer provider. In this regard, an aggregation module (such as the aggregation module 214) of the system 102 may interface with a plurality of offer servers, such as offer servers 220-1, 220-2, . . . , 220-N associated with the plurality of offer providers, via an API. Such API may be defined by the aggregation module 214 based on properties of the offer servers 220. For example, the aggregation module 214 may update or modify an API in order to reliably retrieve offer data 224-1 relating to an offer, from the offer server 220-1.

At block 504, the plurality of offers are segmented based on a set of pre-defined categories. The set of pre-defined categories 226 are defined based on offer provider, offer attributes relating to offer, product offerings, and service offerings to which the offer relates to. In particular, the aggregation module 214 may normalize and enrich an obtained offer data. Further, the aggregation module 214 may segment an offer based on the information provided in the offer data. For example, the offer data indicates offer attributes, such as, type of offer, sector of industry, offer provider, validity, terms and conditions, and so forth. Based on the offer attributes, offer provider, product offerings, and service offerings, the offer may be segmented within one or more of the pre-defined categories 226.

In an example, after normalizing and enriching the offer data, the aggregation module 214 may store the offer data within a memory associated with the system 102 or the aggregation module 214. Such memory may be within the system 102 or remotely located and coupled to the system via communication networks. Further, the aggregation module 214 may retrieve offer provider parameter information relating to the offer provider of the offer. The offer provider parameter information may include offer provider location, such as a geolocation or a website. The aggregation module 214 may then associate the offer with the offer provider location. Further, the aggregation module 214 may segment the offer within pre-defined categories 226.

Examples of the -defined categories 226 may include, but are not limited to, offer type, card type, card platform type, issuer of card, offer provider type, location, and the like. The segmented offer may be stored in a memory associated with the aggregation module 214 as offer data 216. To such an end, the aggregation module 214 may segment the offer data in, for example, table, array, linked list, and the like. In certain cases, aggregation module 214 may validate the offer data periodically to ensure reliability thereof.

At block 506, user information relating to a user is received. Further, target category from the set of pre-defined categories for the user is determined, based on the received user information. For example, the user may provide the user information 222 by signing-in, registering, creating a user profile, opening of web application associated with the system 102, opening of a website associated with the system 102, and the like. In an example, the aggregation module 214 requests the user information such as, preference of the user, a type of card available with user, issuer of the card, platform of the card, location of the user, and the like. The aggregation module 214 does not request for any critical data from the user thus preventing any security threats associated with the critical data of the user. In an example, the aggregation module 214 stores the user information temporarily as user information 222.

Based on the user information 222, target category for the user is determined. In an example, the aggregation module 214 may map attributes of user information 222 with the attributes of the pre-defined categories 226. For example, the user information 222 may include a user location. Further, the aggregation module 214 may determine local geofence of the user, based on the user location. The aggregation module 214 may then determine offer providers having geolocation within the local geofence of the user. In this regard, one of the target categories for the user may be indicative of geolocation. Further, other target categories may be indicative of other user preferences, such as type of card available with the user, a selected category, a user selected offer provider, and the like. In this manner, target category for the user may be determined.

At block 508, offer from the target category may be provided to the user. In an example, the aggregation module 214 may obtain list of offers relating to the target category that may include local geofence of the user. The aggregation module may then transmit the list of offers to the user, via a user device 218.

In an example, the aggregation module 214 may provide a user interface 300 on the user device 218, wherein the user may provide user information 222 and raise a request for offers through the user interface 300. For example, when the user clicks or taps the search button 318 on the user interface, the user may be redirected to an offers page, wherein the list of offers from the target category may be displayed. The user may then select an offer to redeem. In this regard, the aggregation module 214 may receive an indication of a transaction performed by the user, using the selected offer. For example, the offer server 220-1 may provide an indication of a transaction that may be performed by the user at an outlet or a website of the offer provider associated with offer server 220-1. The aggregation module 214 may store transaction information relating to the transaction performed using the selected offer as analytics data 230 for the user. Such analytics data 230 may be used to determine user preference, attitude and tends of purchase of the user, and the like.

In one example, the aggregation module 214 may provide an offer to the user in automated manner and in real-time, i.e., without receiving a request from the user and immediately after receiving new offer data relating to the offer from corresponding offer provider. In such a case, the aggregation module 214 may determine if the received new offer data is relevant to the user based on the user information 222, target category, and segmentation of the offer within the pre-defined categories. In another example, the aggregation module 214 may provide an offer to the user in automated manner based on a geolocation of the user or the user device 218. The offer provided to the user may be redeemed at, for example, an online platform, a store, an outlet, and the like. The aggregation module 214 may also enable the user to provide a feedback pertaining to the offer provided to the user.

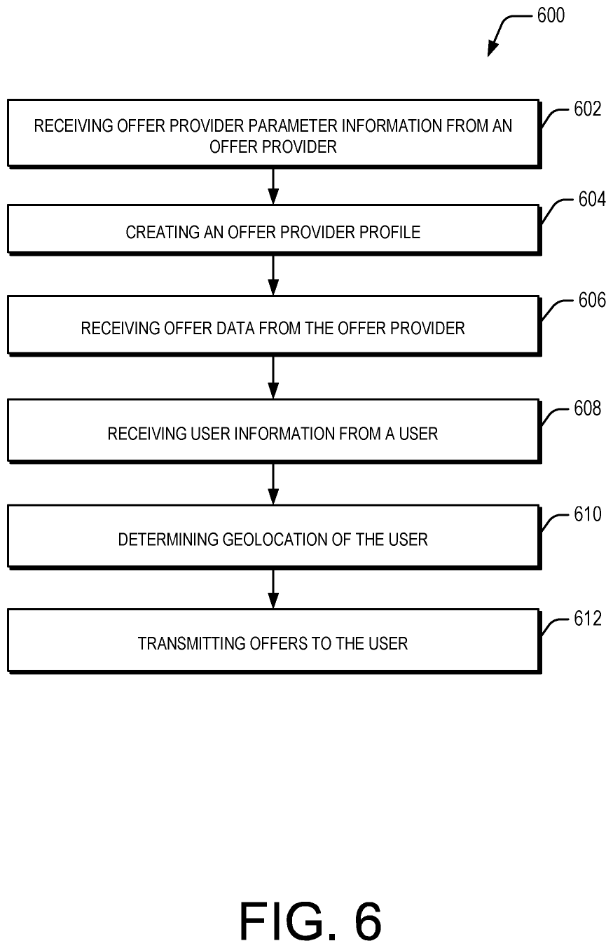

FIG. 6 illustrates a method 600 for receiving information from an offer provider, as per example. Although the method 600 may be implemented for providing the offer by a variety of systems, for the ease of explanation, the present description of the example method 600 is provided in reference to the above-described system 102. The order in which the method 600 is described is not intended to be construed as a limitation, and any number of the described method blocks may be combined in any order to implement the method 600, or an alternative method.

It may be understood that blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 6, at block 602, offer provider parameter information may be received from an offer provider. In this manner the offer provider may register with the system 102 to create an offer provider profile. The offer provider parameter information may include, for example, name, contact details, at least one location associated with offer provider, an industry of service, administrator details relating to the offer provider, a sales verification number relating to the offer provider, and transactional information.

At block 604, an offer provider profile may be created. Based on the offer provider parameter information, the offer provider profile may be created for the offer provider. For example, the system 102 may update the offer provider profile based on activity of the offer provider on the offer provider profile.

At block 606, offer data may be received from the offer provider. In an example, the offer data may include information pertaining to one or more offers provided by the provider. In an example, the one or more offers may relate to same or different service industry. For example, the system 102 may normalize and enrich such offer data relating to one or more offers. Moreover, the system 102 may segment such offer data based on a set of pre-defined categories 226 and store the offer data as offer data 224.

Using the offer provider profile, the offer provider may directly upload offer data onto the system 102. In this regard, the system 102 may also provide a selection of a plurality of templates to the offer provider, via the offer provider profile. The plurality of templates may have, for example design themes, text boxes, selection of media, media box, selection of drop-down menu, touch and/or press buttons, toggle buttons, and the like, to enable the offer provider to create an offer data. For example, the system 102 may provide editing tools, writing tools, formatting tools, uploading tools, and so forth for creation of an offer. Based on the plurality of templates, the offer provider may create an offer data for an offer. Such offer created by an offer provider may be uploaded and made available for use or consumption in real-time.

At block 608, a user information is received from a user. The user may raise a request by logging on a website or app associated with the system 102. In an example, the user may provide user information 222. Moreover, the system 102 may create a user profile based on the user information 222.

At block 610, geolocation of the user is determined. The system 102 may determine the geolocation based on user information 222 or may obtain the geolocation from the user device 218. Based on the geolocation, a geofence for the user may be determined. Further, target categories for the user may be determined. The target categories may be determined based on user information 222 and geofence of the user.

At block 612, offers are transmitted to the user. In particular, offers from the target category may be transmitted to the user based on the geofence, the user information 222. An offer may then be redeemed by the user on the system 102 or a platform associated with the offer provider.

In an example, the offers may be provided to the user in real-time. In particular, an offer provider may upload an offer on the system 102 using the offer provider profile. Such offer may be time-sensitive. The offer data relating to the offer may be normalized and enriched. Further, the system may segment the offer. On determining the offer to relate to a target category of the user, the system 102 may provide the offer to the user. In this manner, such time sensitive offer may be provided to the user in real-time, i.e., as soon as a new offer is uploaded or provided by the offer provider.

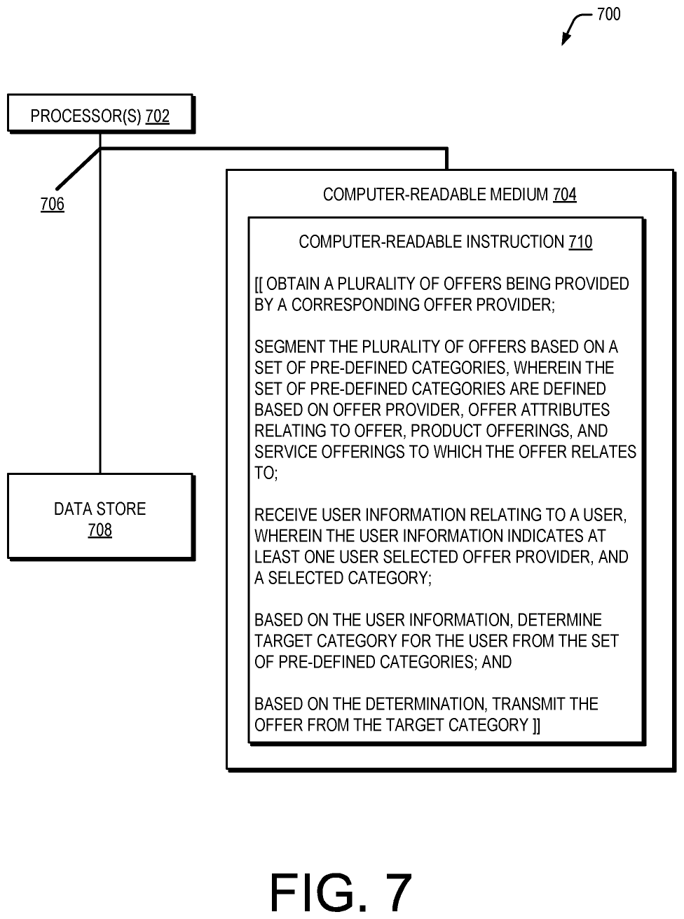

FIG. 7 illustrates a computing environment 700 implementing a non-transitory computer readable medium for automated offer delivery to a user. In an example, the computing environment 700 includes processor(s) 702 communicatively coupled to a non-transitory computer readable medium 704 through a communication link 706. In an example, the processor(s) 702 may have one or more processing resources for fetching and executing computer-readable instructions from the non-transitory computer readable medium 704. The processor(s) 702 and the non-transitory computer readable medium 704 may be implemented, for example, in system 102 (as has been described in conjunction with the FIGS. 1-3).

The non-transitory computer readable medium 704 may be, for example, an internal memory device or an external memory device. In an example implementation, the communication link 706 may be a network communication link. The processor(s) 702 and the non-transitory computer readable medium 704 may be communicatively coupled to a data repository 708 over the network. The processor(s) 702 and the non-transitory computer readable medium 704 may also be communicatively coupled to a user device (such as the user device 218) and a plurality of offer servers (such as the offer servers 220) over the network.

In an example implementation, the non-transitory computer readable medium 704 includes a set of computer readable instructions 710 which may be accessed by the processor(s) 702 through the communication link 706. Referring to FIG. 7, in an example, the non-transitory computer readable medium 704 includes instructions 710 that cause the processor(s) 702 to obtain a plurality of offers being provided by a corresponding offer provider. In an example, an offer provider registers with the system 102 by providing offer provider parameter information. Subsequently, an offer provider profile for the offer provider may be created. For example, the offer provider parameter information may include offer data relating to offer provided by the offer provider, and location information of the offer provider where the offer may be redeemed. Moreover, the offer provider may manage, i.e., updated, modify, add, delete, and the like, the proffered offers, via the offer provider profile.

The instructions 710 may cause the processor(s) 702 to segment the plurality of offers based on a set of pre-defined categories 226. In an example, the aggregation module 214 may receive offer data 224 from the offer servers 220. The aggregation module may then normalize and enrich the offer data 224 and store such offer data 224 in the data store 708. As may be understood, the offer data 224 relates to offers provided by the offer servers 220, or associated offer providers. Moreover, each offer may have corresponding offer attributes, wherein such offer attributes may be determined based on corresponding offer data. Based on the offer provider, offer attributes relating to offer, product offerings, and service offerings to which the offer relates to, the offers may be segmented within the pre-defined categories 226.

Once the offers are segmented, the instructions 710 may further cause the processor(s) 702 to receive user information relating to a user. In an example, the user information 222 may indicates at least one user selected offer provider, and a selected category. In an example, the user may register with the system to receive offers. For example, the user may install browser extension on a user device 218 for a web browser. To run the browser extension, the user may provide user information 222.

The instructions 710 may be executed which cause the processor(s) 702 to determine target category for the user from the set of pre-defined categories 226, based on the user information. For example, the target category for the user may be determined based on, for example, user activity, user preference, user requirement, user location, user demography, a selected category, a selected offer provider, card type, card provider, and the like. In an example, the aggregation module 214 may link the browser extension and user information 222 with the user profile. Subsequently, the aggregation module 214 may retrieve user profile and different associations, for example, based on analytics data 230, associated with the user profile to determine target category for the user.

After determining the target category for the user, the instructions 710 may be executed which cause the processor(s) 702 to transmit the offer from the target category. In an example, the offers may be provided in a list. Such list may be sorted based on, for example, most relevant, highest saving, distance, location, and so forth. For example, the user may select an offer to redeem. the user may then perform a transaction by applying the selected offer on an offer provider's website or on the system 102. In case the user performs the transaction on the system 102, transaction data and user attributes may be suitably linked with the user profile and stored as analytics data 230 for the user.

In an example, the aggregation module 214 may obtain user activity data relating to the user. The user activity data may indicate items that the user may be browsing on a website, such as an e-commerce platform. Subsequently, the aggregation module 214 may determine if the user is initiating a transaction relating to an item on the e-commerce platform. For example, the aggregation module 214 may determine if the user has clicked on “checkout” or “proceed to pay” tabs on the e-commerce platform to initiate a transaction session. Based on the ongoing session, the user information 222, the aggregation module 214 may retrieve offers that may be relevant to ongoing session, wherein such offers may be valid for the ongoing session. The aggregation module 214 may then provide the offers to the user, for example, over a user interface of the e-commerce platform or as notification or message from the browser extension installed on the user device 218.

The aggregation module 214 may authenticate validity of the offers to be provided. Further, the aggregation module 214 may determine impact of validated offers, i.e., amount of savings by each of the validated offers. Further, the aggregation module 214 may also cause to apply a selected offer to the ongoing session, wherein such selected offer may provide highest saving from the list of offers. Further, transaction data relating to such ongoing session and user attributes may be stored as analytics data 230 for the user.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system for automated offer delivery, the system comprising:
a processor;
a machine-readable storage medium comprising instructions executable by the processor to:
obtain a plurality of offers being provided by a corresponding offer provider;
segment the plurality of offers based on a set of pre-defined categories, wherein the set of pre-defined categories are defined based on offer provider, offer attributes relating to offer, product offerings, and service offerings to which the offer relates to;
on receiving user information relating to a user, determine target category for the user from the set of pre-defined categories based on the received user information, wherein the user information indicates at least one user selected offer provider, and a selected category; and
based on the determination, transmit the offer from the target category.

2. The system of claim 1, wherein the user information includes user parameter information relating to the user, and wherein the processor is to:
create a user profile for the user, based on the user information;
dynamically update the user profile based on activity of the user on the user profile.

3. The system of claim 1, wherein, on determining the target category for the user, the processor is to:
authenticate validity of the offer from the target category; and
based on the authentication, transmit validated offer from the target category.

4. The system of claim 1, wherein the processor is to:
obtain user location relating to the user, the user location having an associated local geofence;
based on the offer from the target category, determine an offer within the local geofence of the user; and
transmit the determined offer to the user, based on the user location.

5. The system of claim 1, wherein the processor is to:
receive offer provider parameter information and offer data from an offer provider;
create an offer provider profile for the offer provider, based on the offer provider parameter information and the offer data;
normalize the offer data relating to the offer provided by the offer provider; and
update the offer provider profile based on activity of the offer provider on the offer provider profile.

6. The system of claim 4, wherein the processor is to:
assign relevance score to each of the offer from the target category, wherein the relevance score is assigned based on user selected offer provider, validity, and offer attributes; and
based on the assigned relevance score, transmit a list of the offer from the target category.

7. A method for automated offer delivery, the method comprising:
obtaining a plurality of offers being provided by a corresponding offer provider;
segmenting the plurality of offers based on a set of pre-defined categories, wherein the set of pre-defined categories are defined based on offer provider, offer attributes relating to offer, product offerings, and service offerings to which the offer relates to;
on receiving user information relating to a user, determining target category for the user from the set of pre-defined categories based on the received user information, wherein the user information indicates at least one user selected offer provider, and a selected category; and
based on the determination, transmitting the offer from the target category.

8. The method of claim 7, the method comprising:
receiving a sharing request relating to an offer from the user, wherein the sharing request indicates a second user profile associated with a second user; and
transmitting the offer to the second user.

9. The method of claim 7, the method comprising:
receiving offer provider parameter information from an offer provider;
receiving offer data relating to an offer provided by the offer provider;
creating an offer provider profile for the offer provider, based on the offer provider parameter information and the offer data of the offer; and
normalizing offer data of the offer provided by the offer provider.

10. The method of claim 7, the method comprising:
receiving a request of consumption from the user, wherein the request of consumption relates to an offer, the request of consumption including transaction data relating to the user; and
based on the transaction data relating to the user, causing the user to redeem the offer.

11. The method of claim 9, the method comprising:
receiving, from the user, a reminder setting request relating to an offer;
retrieving offer provider parameter information relating to the offer provider of the offer, wherein the offer provider parameter information includes an offer provider location; and
on determining a location of the user to match with the offer provider location, transmit a reminder relating to the offer to the user.

12. The method of claim 7, the method comprising:
obtaining user transaction history relating to the user, wherein the user transaction history indicates offer providers associated with user transactions performed by the user;
determine a segmentation of the offer providers, based on the set of pre-defined categories; and
based on the segmentation of the offer providers associated with the user transaction history and the user information, segment the user based on the set of pre-defined categories.

13. The method of claim 9, the method comprising:
providing a selection of a plurality of templates to the offer provider, via the offer provider profile; and
causing the offer provider to create of an offer, based on the plurality of templates.

14. A non-transitory computer-readable medium comprising computer-readable instructions being executable by a processing resource to:
obtain a plurality of offers being provided by a corresponding offer provider;
segment the plurality of offers based on a set of pre-defined categories, wherein the set of pre-defined categories are defined based on offer provider, offer attributes relating to offer, product offerings, and service offerings to which the offer relates to; and
receive user information relating to a user, wherein the user information indicates at least one user selected offer provider, and a selected category;
based on the user information, determine target category for the user from the set of pre-defined categories; and
based on the determination, transmit the offer from the target category.

15. The non-transitory computer-readable medium of claim 14, wherein the instructions are to:
authenticate validity of the offer from the target category; and
transmit the validated offer from the target category to the user.

16. The non-transitory computer-readable medium of claim 14, wherein the instructions are to:
based on the user information and the target category for the user, determine at least one offer provider;
send a trigger to the determined at least one offer provider, wherein the trigger indicates a user profile relating to the user;
receive a first offer from the offer provider; and
transmit the first offer to the user.

17. The non-transitory computer-readable medium of claim 14, wherein the instructions are to:
determine an amount of benefit associated with the determined offer from the target category; and
based on the determination, cause to indicate a selected offer to the user, wherein the amount of benefit associated with the selected offer is highest.

18. The non-transitory computer-readable medium of claim 14, wherein the instructions are to:
obtain user activity data relating to the user, wherein the user activity data indicates an ongoing session;
based on the user activity data and the user information, determine an offer for the user; and
cause to apply the determined offer to the ongoing session.

19. The non-transitory computer-readable medium of claim 14, wherein the instructions are to:
determine a relevance score for each of the offer from the target category to be provided to the user, based on corresponding offer provider profile parameter information, validity, the user information and an amount of saving;
arrange the offer from the target category in a list, based on the corresponding relevance score; and
transmit the list of the offer from the target category to the user.

20. The non-transitory computer-readable medium of claim 14, wherein the instructions are to:
provide a selection of a plurality of templates to the offer provider; and
cause the offer provider to create of an offer, based on the plurality of templates.
